(19) United States
(12) Patent Application Publication
(10) Pub. No.: US 2026/0006505 A1
(43) Pub. Date: Jan. 1, 2026

(54) INDICATING CELL SWITCH-OFF TO IDLE OR INACTIVE USER EQUIPMENTS

(71) Applicant: QUALCOMM Incorporated, San Diego, CA (US)

(72) Inventors: Sherif ELAZZOUNI, San Diego, CA (US); Navid ABEDINI, Basking Ridge, NJ (US); Naeem AKL, BRIDGEWATER, NJ (US)

(21) Appl. No.: 18/759,388

(22) Filed: Jun. 28, 2024

(51) Int. Cl. H04W 36/00; H04W 24/08; H04W 36/08; H04W 76/20

(52) U.S. Cl. CPC H04W 36/008357; H04W 24/08; H04W 36/08; H04W 76/20

(57) ABSTRACT

Methods, systems, and devices for wireless communications are described. The described techniques may enable a UE to identify that a network entity may enter a network energy savings (NES) mode while the UE is in an idle or inactive mode. For example, the network entity may indicate to the UE that the network entity is capable of entering the NES mode. In some examples, the indication may include a list of one or more candidate cells to which the UE may reselect. The network entity may indicate to the UE that the network entity will enter the NES mode. In some examples, the network entity may indicate a time at which the network entity may enter the NES mode or a duration until the network entity may enter the NES mode. The UE may accordingly perform a cell reselection procedure according to the list of candidate cells.

### FIELD OF TECHNOLOGY

The following relates to wireless communications, including indicating cell switch-off to idle or inactive user equipments.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a first message indicating that a network entity is capable of entering a first mode of operation in which the network entity is unavailable for communications, receiving, while the UE is in an idle mode or an inactive mode, a second message indicating for the UE to perform a cell reselection based on an upcoming entrance of the network entity into the first mode of operation, and performing the cell reselection in response to receiving the second message.

A UE for wireless communications is described. The UE may include one or more memories storing processor executable code, a transceiver, and one or more processors coupled with the one or more memories and the transceiver. The one or more processors may individually or collectively be operable to execute the code to cause the UE to receive, via the transceiver, a first message indicating that a network entity is capable of entering a first mode of operation in which the network entity is unavailable for communications, receive, via the transceiver while the UE is in an idle mode or an inactive mode, a second message indicating for the UE to perform a cell reselection based on an upcoming entrance of the network entity into the first mode of operation, and perform the cell reselection in response to receiving the second message.

Another UE for wireless communications is described. The UE may include means for receiving a first message indicating that a network entity is capable of entering a first mode of operation in which the network entity is unavailable for communications, means for receiving, while the UE is in an idle mode or an inactive mode, a second message indicating for the UE to perform a cell reselection based on an upcoming entrance of the network entity into the first mode of operation, and means for performing the cell reselection in response to receiving the second message.

A non-transitory computer-readable medium storing code for wireless communications is described. The code may include instructions executable by one or more processors to receive a first message indicating that a network entity is capable of entering a first mode of operation in which the network entity is unavailable for communications, receive, while the UE is in an idle mode or an inactive mode, a second message indicating for the UE to perform a cell reselection based on an upcoming entrance of the network entity into the first mode of operation, and perform the cell reselection in response to receiving the second message.

In some examples of the method, UEs, and non-transitory computer-readable medium described herein, performing the cell reselection may include operations, features, means, or instructions for establishing a connection with a first network entity from among the one or more additional network entities based on the list of the one or more additional network entities.

In some examples of the method, UEs, and non-transitory computer-readable medium described herein, receiving the first message may include operations, features, means, or instructions for receiving, via the first message, an indication of a time at which the network entity will enter into the first mode of operation, a duration until the network entity will enter the first mode of operation, a periodicity associated with the second message, a transmission time for the second message, encoding information associated with the second message, or any combination thereof.

In some examples of the method, UEs, and non-transitory computer-readable medium described herein, receiving the second message may include operations, features, means, or instructions for receiving an indication of a change in a synchronization signal block (SSB) configuration, an indication that one or more additional cells will enter the first mode of operation, an indication of a time at which the network entity will enter into the first mode of operation, an indication of a duration until the network entity will enter the first mode of operation, an indication of a time at which the network entity will exit the first mode of operation, an indication of a time pattern including one or more first durations that the network entity will be in the first mode of operation and one or more second durations that the network entity will not be in the first mode of operation, or any combination thereof.

In some examples of the method, UEs, and non-transitory computer-readable medium described herein, receiving the second message may include operations, features, means, or instructions for receiving an indication that the second message may be intended for the UE, where performing the cell reselection may be based on the second message being intended for the UE.

In some examples of the method, UEs, and non-transitory computer-readable medium described herein, performing the cell reselection may include operations, features, means, or instructions for performing the cell reselection based on one or more reselection criteria, where the one or more reselection criteria may be based on a quality associated with one or more additional network entities, and where the one or more reselection criteria may be independent of a quality associated with the network entity.

Some examples of the method, UEs, and non-transitory computer-readable medium described herein may further include operations, features, means, or instructions for receiving one or more system information blocks (SIBs) indicating the one or more reselection criteria, where the one or more reselection criteria include one or more parameters associated with the first mode of operation.

In some examples of the method, UEs, and non-transitory computer-readable medium described herein, the first message includes a SIB message or a radio resource control (RRC) message.

In some examples of the method, UEs, and non-transitory computer-readable medium described herein, the second message includes a SIB message, a paging message, or a downlink control information (DCI) message.

In some examples of the method, UEs, and non-transitory computer-readable medium described herein, the first message may be received while the UE may be in the idle mode or the inactive mode.

A method for wireless communications by a network entity is described. The method may include outputting, to a UE, a first message indicating that the network entity is capable of entering a first mode of operation in which the network entity is unavailable for communications, where the first message indicates for the UE to monitor for a second message while the UE is in an idle or inactive state, outputting the second message to the UE, where the second message indicates for the UE to perform a cell reselection based on an upcoming entrance of the network entity into the first mode of operation, and entering the first mode of operation based on outputting the second message.

A network entity for wireless communications is described. The network entity may include one or more memories storing processor executable code, and one or more processors coupled with the one or more memories. The one or more processors may individually or collectively be operable to execute the code to cause the network entity to output, to a UE, a first message indicating that the network entity is capable of entering a first mode of operation in which the network entity is unavailable for communications, where the first message indicates for the UE to monitor for a second message while the UE is in an idle or inactive state, output the second message to the UE, where the second message indicates for the UE to perform a cell reselection based on an upcoming entrance of the network entity into the first mode of operation, and enter the first mode of operation based on outputting the second message.

Another network entity for wireless communications is described. The network entity may include means for outputting, to a UE, a first message indicating that the network entity is capable of entering a first mode of operation in which the network entity is unavailable for communications, where the first message indicates for the UE to monitor for a second message while the UE is in an idle or inactive state, means for outputting the second message to the UE, where the second message indicates for the UE to perform a cell reselection based on an upcoming entrance of the network entity into the first mode of operation, and means for entering the first mode of operation based on outputting the second message.

A non-transitory computer-readable medium storing code for wireless communications is described. The code may include instructions executable by one or more processors to output, to a UE, a first message indicating that the network entity is capable of entering a first mode of operation in which the network entity is unavailable for communications, where the first message indicates for the UE to monitor for a second message while the UE is in an idle or inactive state, output the second message to the UE, where the second message indicates for the UE to perform a cell reselection based on an upcoming entrance of the network entity into the first mode of operation, and enter the first mode of operation based on outputting the second message.

In some examples of the method, network entities, and non-transitory computer-readable medium described herein, the first message may be associated with a list of one or more additional network entities, the one or more additional network entities associated with one or more candidate cells for the cell reselection.

In some examples of the method, network entities, and non-transitory computer-readable medium described herein, outputting the first message may include operations, features, means, or instructions for outputting, via the first message, an indication of a time at which the network entity will enter into the first mode of operation, a duration until the network entity will enter the first mode of operation, a periodicity associated with the second message, a transmission time for the second message, encoding information associated with the second message, or any combination thereof.

In some examples of the method, network entities, and non-transitory computer-readable medium described herein, outputting the second message may include operations, features, means, or instructions for outputting an indication of a change in a SSB configuration, an indication that one or more additional cells will enter the first mode of operation, an indication of a time at which the network entity will enter into the first mode of operation, an indication of a duration until the network entity will enter the first mode of operation, an indication of a time at which the network entity will exit the first mode of operation, an indication of a time pattern including one or more first durations that the network entity will be in the first mode of operation and one or more second durations that the network entity will not be in the first mode of operation, or any combination thereof.

In some examples of the method, network entities, and non-transitory computer-readable medium described herein, outputting the second message may include operations, features, means, or instructions for outputting an indication that the second message may be intended for the UE.

Some examples of the method, network entities, and non-transitory computer-readable medium described herein may further include operations, features, means, or instructions for outputting one or more SIBs indicating one or more reselection criteria, where the one or more reselection criteria include one or more parameters associated with the first mode of operation.

In some examples of the method, network entities, and non-transitory computer-readable medium described herein, the first message includes a SIB message or an RRC message.

In some examples of the method, network entities, and non-transitory computer-readable medium described herein, the second message includes a SIB message, a paging message, or a DCI message.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports indicating cell switch-off to idle or inactive user equipments (UEs) in accordance with one or more aspects of the present disclosure.

FIG. 2 shows an example of a wireless communications system that supports indicating cell switch-off to idle or inactive UEs in accordance with one or more aspects of the present disclosure.

FIG. 3 shows an example of a process flow that supports indicating cell switch-off to idle or inactive UEs in accordance with one or more aspects of the present disclosure.

FIGS. 4 and 5 show block diagrams of devices that support indicating cell switch-off to idle or inactive UEs in accordance with one or more aspects of the present disclosure.

FIG. 6 shows a block diagram of a communications manager that supports indicating cell switch-off to idle or inactive UEs in accordance with one or more aspects of the present disclosure.

FIG. 7 shows a diagram of a system including a device that supports indicating cell switch-off to idle or inactive UEs in accordance with one or more aspects of the present disclosure.

FIGS. 8 and 9 show block diagrams of devices that support indicating cell switch-off to idle or inactive UEs in accordance with one or more aspects of the present disclosure.

FIG. 10 shows a block diagram of a communications manager that supports indicating cell switch-off to idle or inactive UEs in accordance with one or more aspects of the present disclosure.

FIG. 11 shows a diagram of a system including a device that supports indicating cell switch-off to idle or inactive UEs in accordance with one or more aspects of the present disclosure.

FIGS. 12 through 16 show flowcharts illustrating methods that support indicating cell switch-off to idle or inactive UEs in accordance with one or more aspects of the present disclosure.

### DETAILED DESCRIPTION

In some wireless communication systems, a network entity may perform a cell switch-off and enter a network energy savings (NES) mode (e.g., a switch-off mode) to decrease power consumption of the network entity. For example, the network entity may indicate for one or more user equipments (UEs) that are in communication with the network entity to perform a cell reselection to another network entity. In examples in which the network entity may offload all UEs served by the network entity, the network entity may enter the NES mode (e.g., a mode of operation in which the network entity may not be available for communication with one or more UEs). In some examples, however, one or more UEs that are camped on a cell of the network entity may be in an idle or inactive state and may therefore not receive the indication to perform the cell reselection. In such examples, the one or more UEs may identify that the network entity is no longer available and may perform a reselection after entering an active mode, which may increase latency associated with cell reselection and therefore may increase processing and power consumption of the one or more UEs.

Techniques described herein may enable a UE to identify that the network entity may enter the NES mode while the UE is in the idle or inactive mode. For example, the network entity may indicate to the UE (e.g., via a system information block (SIB) or radio resource control (RRC) message while the UE is in the active, idle, or inactive mode) that the network entity is capable of entering the NES mode. In some examples, the indication may include a list of one or more candidate cells to which the UE may reselect. The network entity may later indicate to the UE (e.g., via a SIB, paging message, or downlink control information (DCI) while the UE is in the idle or inactive mode) that the network entity will enter the NES mode. In some examples, the network entity may indicate a time at which the network entity may enter the NES mode and/or a duration until the network entity may enter the NES mode. The UE may accordingly perform a cell reselection procedure according to the list of candidate cells, which may decrease latency associated with cell reselection.

Aspects of the disclosure are initially described in the context of wireless communications systems. Aspects of the disclosure are further illustrated by and described with reference to process flows, apparatus diagrams, system diagrams, and flowcharts that relate to indicating cell switch-off to idle or inactive UEs.

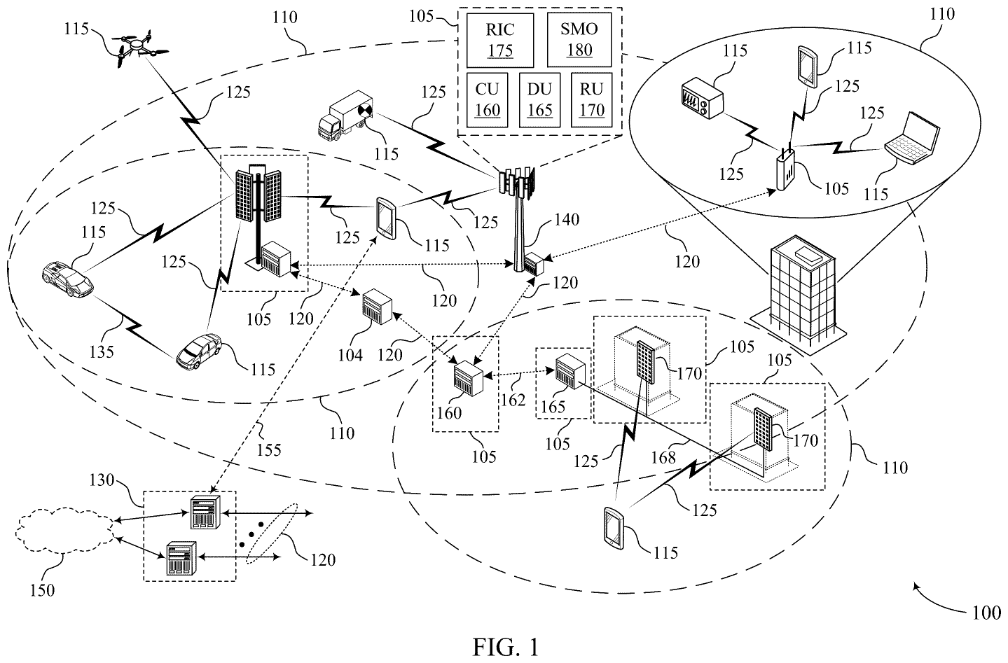

FIG. 1 shows an example of a wireless communications system 100 that supports indicating cell switch-off to idle or inactive UEs in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 or network entities 105 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 or network entities 105 may include entering a power saving deep sleep mode when not engaging in active communications (e.g., a shut-off mode or NES mode), operating using a limited bandwidth (e.g., according to narrowband communications), operating using discontinuous reception (DRX) and/or discontinuous transmission (DTX), or a combination of these techniques. For example, some UEs 115 or network entities 105 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples of the wireless communication system 100, a UE 115 may identify that a network entity 105 (e.g., a network entity 105 that the UE 115 is camped on or served by) may enter an NES mode while the UE 115 is in an idle or inactive mode. As described herein, the NES mode may be a mode of operation in which the network entity 105 is unavailable for communication. For example, the network entity 105 may indicate to the UE 115 (e.g., via a SIB or RRC message while the UE 115 is in an active, idle, or inactive mode) that the network entity 105 is capable of entering the NES mode. In some examples, the indication may include a list of one or more candidate cells (e.g., one or more neighbor network entities 105) to which the UE 115 may reselect. The network entity 105 may later indicate to the UE 115 (e.g., via a SIB, paging message, or DCI while the UE 115 is in the idle or inactive mode) that the network entity 105 will enter the NES mode. In some examples, the network entity 105 may indicate a time at which the network entity 105 may enter the NES mode and/or a duration until the network entity 105 may enter the NES mode. The UE 115 may accordingly perform a cell reselection procedure according to the list of candidate cells, which may decrease latency associated with cell reselection.

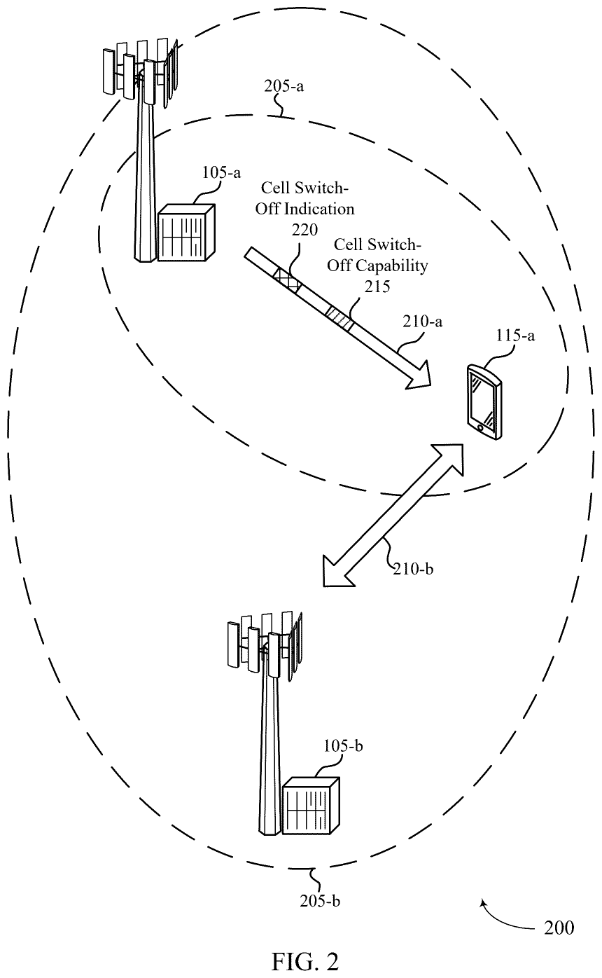

FIG. 2 shows an example of a wireless communications system 200 that supports indicating cell switch-off to idle or inactive UEs in accordance with one or more aspects of the present disclosure. The wireless communications system 200 may implement or may be implemented by aspects of the wireless communications system 100. For example, the wireless communications system 200 may be implemented by a UE 115 (e.g., a UE 115-a) or one or more network entities 105 (e.g., a network entity 105-a, a network entity 105-b), which may be examples of the corresponding devices as described with reference to FIG. 1.

In some examples of the wireless communications system 200, a UE 115-a may operate in a cell 205-a of a network entity 105-a. For example, the UE 115-a may communicate with the network entity 105-a via one or more channels 210 (e.g., a channel 210-a). The network entity 105-a may be in a normal communication mode while in communication with the UE 115-a.

In some examples, the network entity 105-a may be an example of an NES cell that may enter an NES mode in which the network entity 105-a is unavailable for communication. In such examples, the network entity 105-a may configure one or more UEs 115 in a connected mode with an inactive conditional handover (CHO) configuration (e.g., an NES-CHO A3/A4/A5 event configuration via RRC) for performing a cell reselection to another network entity 105 (e.g., a network entity 105-d, another neighboring network entity 105). The network entity 105-a may activate the CHO configuration (e.g., via group L1 signaling to the UEs 115). The UEs 115 may accordingly evaluate one or more NES-CHO conditions to exit the cell 205-a and reselect to a cell 205-b of the network entity 105-b (e.g., if an event associated with the NES-CHO conditions is true). In examples in which the network entity 105-a offloads all UEs 115 in communication with the network entity 105-a, the network entity 105-a may enter the NES mode and may therefore reduce power consumption of the network entity 105-a.

In some examples, the network entity 105-a may active the NES-CHO configuration via a group common DCI (e.g., DCI format 2_9). For example, the DCI may include one or more bits in a physical cell (PCell) block to trigger cell DTX activation and cell DRX activation, and an additional bit of the PCell block to indicate cell switch-off (e.g., the network entity 105-a entering the NES mode) and therefore to activate the NES-CHO configuration. The DCI (e.g., the L1 signaling) may not trigger the UEs 115 to perform measurements. The network entity 105-a may not transmit synchronization signal blocks (SSBs), SIBs, or one or more other messages while in the NES mode.

In some examples, the UE 115-a may be a UE 115 that may operate in an idle or inactive mode (e.g., a mode in which the UE 115-a refrains from monitoring for one or more messages from the network entity 105-a). For example, the UE 115-a may deactivate a radio of the UE 115-a, and may periodically reactivate the radio to monitor for one or more paging messages from the network entity 105-a. In the idle or active mode, the UE 115-a may be camped on the cell 205-a. In such examples, the network entity 105-a may not be aware that the UE 115-a is camped on the cell 205-a and may enter the NES mode after offloading one or more other UEs 115 in communication with the network entity 105-a.

The network entity 105-a may therefore not instruct the UE 115-a to active the NES-CHO configuration, and the UE 115-a in the idle or inactive mode may use idle mode mobility to perform cell reselection. For example, the UE 115-a may not evaluate one or more neighbor cells (e.g., the cell 205-b) for reselection until after the network entity 105-a performs cell switch-off, which may increase latency associated with cell reselection (e.g., due to a time until one or more new measurements are triggered, such as when a lack of SSBs from the network entity 105-a cause reselection criteria to be satisfied, and a time taken to identify a cell 205-b that satisfies one or more quality thresholds).

For example, the UE 115-a may not evaluate neighbor cells 205 for reselection until one or more reselection criteria are satisfied. In some examples, for intra-frequency reselection (e.g., to a cell 205 in a same frequency band as the cell 205-a), the UE 115-a may not evaluate neighbor cells until a parameter S_{serving} is less than a parameter S_{IntrasearchP} and/or until a parameter S_{qual} of the serving cell is less than a parameter S_{IntraSearchQ}, where S_{serving} is a cell selection received power (e.g., in dB) of the serving cell 205-a, S_{IntrasearchP} is a cell selection received power threshold (e.g., in dB) for intra-frequency measurements, S_{qual} is a cell selection quality of the serving cell 205-a (e.g., in dB) and S_{IntraSearchQ} is a cell selection quality threshold (e.g., in dB) for intra-frequency measurements. In some examples, one or more intra-frequency reselection criteria may be received via SIB3, S_{IntrasearchP} and S_{IntraSearchQ} may be received via SIB2, and S_{serving} and S_{qual} may be measured quantities.

For inter-frequency reselection (e.g., to a cell 205 in a different frequency band as the cell 205-a), the UE 115-a may not evaluate neighbor cells until a parameter ReselPrio_{othFreq} is greater than a parameter ReselPrio_{SerFreq} and/or until the parameter S_{serving} is less than a parameter S_{nonIntrasearchP}, where ReselPrio_{othFreq} is a priority of reselecting to another frequency band, ReselPrio_{SerFreq} is a priority of remaining in a same frequency band, and S_{nonIntrasearchP} is a cell selection received power threshold (e.g., in dB) for inter-frequency measurements. In some examples, one or more inter-frequency reselection criteria such as ReselPrio_{othFreq} may be received via SIB4, S_{IntersearchP} and ReselPrio_{SerFreq} may be received via SIB2, and S_{serving} may be a measured quantity.

Additionally, if the UE 115-a performs a random access channel (RACH) procedure while camped on the cell 205-a while the network entity 105-a is in the NES mode, a connection may fail due to switch-off of the cell 205-a, which may result in a loss of connectivity for the UE 115-a.

Accordingly, techniques described herein may define a mechanism for the network entity 105-a to instruct the UE 115-a in the idle or inactive mode to perform cell reselection due to the network entity 105-a entering the NES mode (e.g., performing cell switch-off). For example, the network entity 105-a may transmit a cell switch-off capability 215 to the UE 115-a (e.g., when the UE 115-a is in the active, idle, or inactive mode) indicating that the network entity 105-a may perform cell switch-off and enter the NES mode. That is, the cell switch-off capability 215 may indicate that the cell 205-a is a candidate for switch-off and that the UE 115-a may receive a cell switch-off indication 220 indicating for the UE 115-a to perform cell reselection. In some examples, the cell switch-off capability 215 may indicate a list of neighboring cells (e.g., the cell 205-b of the network entity 105-b) that may be candidate cells for reselection upon receiving the cell switch-off indication 220.

In some examples, the cell switch-off capability 215 may be a SIB indication (e.g., a SIB2 that controls one or more reselection rules). For example, a SIB2 may include one or more fields indicating one or more of an indication that the cell 205-a may dynamically switch-off and/or a time until switch-off (e.g., an absolute time planned for switch-off of the cell 205-a or a time between a time at which the UE 115-a receives the cell switch-off indication 220 and a time at which the network entity 105-a performs the switch-off, such as a time for the UE 115-a to successfully perform reselection). In some examples, the cell switch-off capability 215 may indicate a configuration of an L1 message that may carry the cell switch-off indication 220, such as a time for the UE 115-a to monitor for the cell switch-off indication 220 (e.g., an SFN, a periodicity of the cell switch-off indication 220), a frequency for the UE 115-a to monitor for the cell switch-off indication 220 (e.g., one or more physical downlink control channel (PDCCH) resources), and/or an identifier used for encoding or scrambling of the cell switch-off indication 220 (e.g., a radio network temporary identifier (RNTI)).

Additionally, or alternatively, the UE 115-a may receive the cell switch-off indication 220 via an RRC message when the UE 115-a is in a connected mode with the network entity 105-a. For example, the cell switch-off capability 215 may be part of an RRCSuspend or RRCRelease configuration for inactive or idle UEs 115, respectively. In some examples, the cell switch-off capability 215 may reuse the NES-CHO configuration. For example, the NES-CHO configuration may include an NES-CHO configuration for UEs 115 in the idle or inactive mode. Such techniques may mix connected and idle or inactive mode signaling. In some examples, the UE 115-a may receive a DCI (e.g., a DCI format 2_9) including the cell switch-off indication 220. For example, the cell switch-off capability 215 may indicate one or more parameters (e.g., CellDTRXRNTI) for the DCI format 2_9 for the UE 115-a to monitor. In some examples, the DCI may have a same configuration of a DCI for one or more connected or active UEs 115 and/or may have a slower periodicity of the DCI for the connected or active UEs 115.

The UE 115-a may receive the cell switch-off indication 220 while the UE 115-a is in the idle or inactive mode indicating that the cell 205-a may be switched off due to the network entity 105-a entering the NES mode. In some examples, the cell switch-off indication 220 may be a modified paging message. For example, the network entity 105-a may transmit a short message (e.g., relatively shorter than one or more other messages) indicating an upcoming entrance of the network entity 105-a into the NES mode. In some examples, the cell switch-off indication 220 may be a system information (SI) modification (e.g., such as a message indicating a new SSB configuration or a change in SSB periodicity).

In some examples, the cell switch-off indication may include an indication that the network entity 105-a will perform cell switch-off and enter the NES mode, an indication that one or more neighbor cells 205 will switch-off and enter the NES mode, an indication of a time until the network entity 105-a performs cell switch-off, an indication of a scheduled time at which the network entity 105-a will perform cell switch off, or an indication of a scheduled time at which the cell 205-a will switch back on (e.g., due to the network entity 105-a exiting the NES mode). For example, the cell switch-off indication may include a pattern of time periods during which the network entity 105-a may be in the NES mode and time periods during which the network entity 105-a may not be in the NES mode.

In some examples, the cell switch-off capability 215 and the cell switch-off indication 220 may be indicated via separate messages (e.g., via two different messages of different types; or via two different messages of a same type, such as two different messages of the same type but sent separately at the same time or at different times). In some examples, the cell switch-off capability 215 and the cell switch-off indication 220 may be indicated via a same message (e.g., via a single message that includes both the cell switch-off capability 215 and the cell switch-off indication 220). The cell switch-off indication 220 may be indicated via a same type of message as the cell switch-off capability 215 (e.g., both may be indicated via a SIB) or via a different type of message from the cell switch-off capability 215 (e.g., the cell switch-off capability 215 may be indicated via a SIB, and the cell switch-off indication 220 may be indicated via a paging message or DCI message).

In some examples, the network entity 105-a may transmit the cell switch-off indication 220 to offload a group of UEs 115 (e.g., a subset of UEs 115 in communication with the network entity 105-a that satisfy one or more criteria), such as by implying an DTX/DRX configuration or to reduce power consumption of the network entity 105-a. For example, one or more UEs 115 in communication with the network entity 105-a may receive a configuration (e.g., via the cell switch-off capability 215 or another message from the network entity 105-a) for a short message including the cell switch-off indication 220 (e.g., depending on one or more QoS parameters or types of UEs 115). Accordingly, the network entity 105-a may transmit a different short message including the cell switch-off indication 220 to instruct one or more different groups of UEs 115 to perform cell reselection. In such examples, each UE 115 may identify whether a received cell switch-off indication 220 is intended for the UE 115 (e.g., based on a configuration used to transmit the short message) and may perform cell reselection upon identifying that the cell switch-off indication 220 is intended for the UE 115-a.

In some examples, the cell switch-off indication 220 may inform the UE 115-a of one or more other changes of the cell 205-a on which the UE 115-a is camped. For example, the cell switch-off indication 220 may indicate changes in SSBs, RACH occasion (ROs), paging adaption, on-demand SIB1, and so on. Accordingly, the UE 115-a may obtain information related to cell reselection or transitioning from the idle or inactive mode to an RRC Connected mode, or information related to changing one or more idle or inactive mode measurements.

In some examples, if NES information (e.g., the cell switch-off indication 220) is indicated via a SIB (e.g., a SIB other than a SIB1, a SIB2, or a SIB3), an SI modification may inform the UE 115-a to acquire the SIB. In some examples, one or more SIBs (e.g., a SIB1, a SIB2, a SIB3, or another SIB) may include reselection information (e.g., one or more reselection criteria) for UEs 115 in communication with the network entity 105-a.

The UE 115-a may trigger cell reselection based on receiving the cell switch-off indication 220 (e.g., an explicit trigger to perform cell reselection) and based on the one or more reselection criteria. Accordingly, the UE 115-a may establish a connection with the network entity 105-b and may communicate with the network entity 105-b via one or more channels 210-b.

For example, a SIB3 may indicate one or more intra-frequency reselection criteria (e.g., if the candidate cell 205-b operates in a same frequency band as the cell 205-a). In some examples, the intra-frequency reselection criteria may be that the cell switch-off indication 220 (e.g., a paging NES indication) is received, and that an intra-frequency neighbor cell 205 is a suitable cell (e.g., with a cell selection received power Sᵣₓₗₑᵥ (e.g., in dB) and a cell selection quality S_{qual} (e.g., in dB) that are greater than 0. The UE 115-a may not perform any comparison to the cell 205-a (e.g., as the cell 205-a may be switched off and therefore a quality or strength of the cell 205-a may be irrelevant). Sᵣₓₗₑᵥ and S_{qual} may be measured quantities.

Additionally, or alternatively, a SIB4 and/or a SIB2 may indicate one or more inter-frequency reselection criteria (e.g., if the candidate cell 205-b operates in a different frequency band as the cell 205-a). In some examples, the inter-frequency reselection criteria may be that the cell switch-off indication 220 (e.g., a paging NES indication) is received, and that ReselPrio_{othFreq} is higher than ReselPrio_{SerFreq} or that S_{IntraSearchP} is less than S_{nonIntraSearchP} and that ReselPrio_{othFreq} is higher than ReselPrio_{SerFreq}. The UE 115-a may receive ReselPrio_{othFreq} via a SIB4 and may receive ReselPrio_{SerFreq} and S_{nonIntraSearchP} via a SIB2. S_{IntraSearchP} may be a measured quantity. The UE 115-a may not perform any comparison to the cell 205-a (e.g., as the cell 205-a may be switched off and therefore a quality or strength of the cell 205-a may be irrelevant), and may instead compare inter-frequency cells 205 with intra-frequency cells 205.

In some examples, a SIB3 and/or a SIB4 from the network entity 105-a may indicate one or more selection criteria that are different for normal reselection and reselection from a cell 205-a that has been switched off. For example, if the network entity 105-a performs cell switch-off for some frequencies, the UE 115-a may receive different cell selection rules for a case in which the UE 115-a receives the cell switch-off indication 220 and a case in which the UE 115-a does not receive the cell switch-off indication 220.

For example, a SIB2 may indicate NES-specific cell received power thresholds (e.g., S_{IntrasearchP_NES} and S_{nonintrasearchP_NES}), quality thresholds (e.g., S_{IntraSearchQ_NES}), reselection priorities (e.g., ReselPrio_{SerFreq_NES} or ReselPrio_{SerFreq_NES}), and/or reselection criteria such as a cell reselection timer value T_{ReselectionNR_NES}, a hysteresis value Q_{hyst_NES}, and/or a received power threshold Thresh_{servinglowP_NES} for reselecting to a lower priority RAT or frequency. Additionally, or alternatively, a SIB3 may indicate an offset parameter Q_{offset_NES}. Additionally, or alternatively, a SIB4 may indicate a reselection priority ReselPrio_{othFreq_NES} and/or a received power threshold Thresh_{x, HighP_NES} for reselecting towards a higher priority RAT or frequency.

In some examples (e.g., depending on whether the UE 115-a receives the cell switch-off indication 220), the UE 115-a may consider one or more normal reselection parameters or the one or more NES-specific reselection parameters. That is, depending on which cells 205 may be switched off (e.g., as indicated via the cell switch-off indication 220), the UE 115-a may be disincentivized from performing a reselection to another NES cell that may enter the NES mode based on the NES-specific reselection parameters.

In some examples, a network entity 105-a may use the techniques described herein to instruct a camped UE 115-a to reselect to another cell 205-b based on a change in SSB or SIBs from periodic to on-demand. For example, changes in SSB or SIB configurations may affect an ability of the UE 115-a to connect to, camp on, or perform measurements of the cell 205-a. Accordingly, the network entity 105-a may instruct the UE 115-a to reselect to another cell (e.g., the cell 205-b).

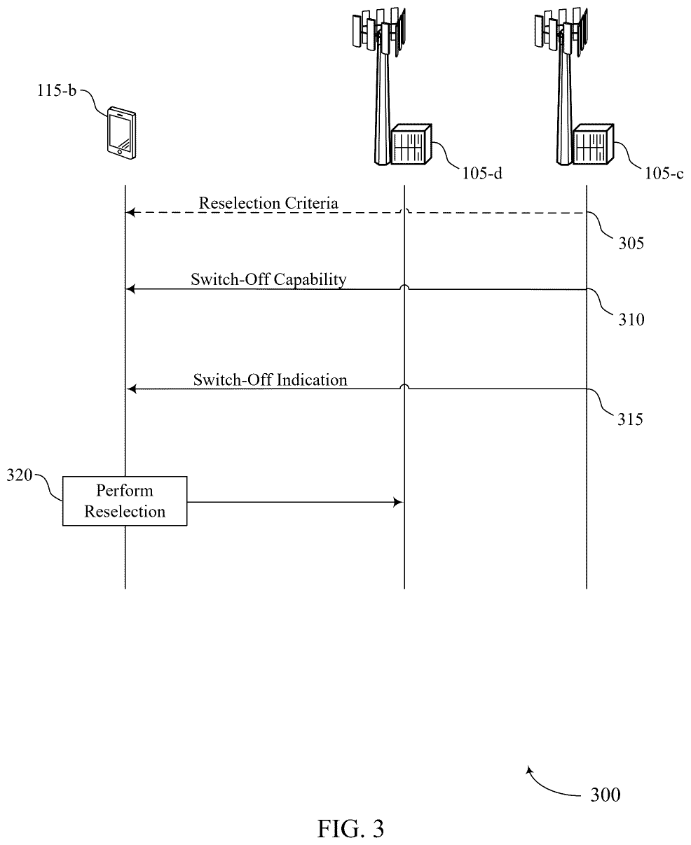

FIG. 3 shows an example of a process flow 300 that supports indicating cell switch-off to idle or inactive UEs in accordance with one or more aspects of the present disclosure. The process flow 300 may implement or may be implemented by aspects of the wireless communications system 100 or the wireless communication system 200. For example, the wireless communications system 200 may be implemented by a UE 115 (e.g., a UE 115-b) or one or more network entities 105 (e.g., a network entity 105-c, a network entity 105-d), which may be examples of the corresponding devices as described with reference to FIG. 1.

In the following description of the process flow 300, the operations between the UE 115-b, the network entity 105-c, and the network entity 105-d may occur in a different order than the example order shown and, in some examples, may be performed by one or more different devices other than those shown as examples. Some operations also may be omitted from the process flow 300, and other operations may be added to the process flow 300. Further, although some operations or signaling may be shown to occur at different times for discussion purposes, these operations may actually occur at the same time.

In some examples, at 305, the UE 115-b may receive one or more reselection criteria for the UE 115-b to perform a cell reselection procedure. In some examples, the one or more reselection criteria may be one or more parameters associated with performing reselection from a network entity 105-c when the network entity 105-c is operating in an NES mode (e.g., a mode of operation in which the network entity 105-c is unavailable for communication with the UE 115-b). In some examples, the UE 115-b may receive the reselection criteria via one or more SIBs (e.g., a SIB1, a SIB2, and/or a SIB3) from the network entity 105-c or from another network entity 105. The reselection criteria may be based on a quality of communications (e.g., RSRP, SINR, SNR, and the like) associated with one or more other network entities 105 (e.g., a network entity 105-d). In some examples, the reselection criteria may be independent of a quality of communications associated with the network entity 105-c.

At 310, the UE 115-b may receive a first message (e.g., a switch-off capability message) from the network entity 105-c indicating that the network entity 105-c is capable of entering the NES mode. In some examples, the first message may indicate for the UE 115-b to monitor for a second message (e.g., a switch-off indication message) from the network entity 105-c while the UE 115-b is operating in an idle or inactive mode. In some examples, the first message may indicate a list of one or more candidate network entities 105 (e.g., neighboring network entities 105) to which the UE 115-b may reselect upon receiving the second message.

In some examples, the first message may include an indication of a time at which the network entity 105-c may enter into the first mode of operation, a duration until the network entity 105-c may enter the first mode of operation, a periodicity associated with the second message, a transmission time for the second message, and/or encoding information associated with the second message. In some examples, the first message may be a SIB (e.g., a SIB2 or another SIB) or an RRC message. The UE 115-b may receive the first message while the UE 115-b is in an active mode or when the UE 115-b is in the idle or inactive mode.

At 315, the UE 115-b may receive the second message (e.g., the switch-off indication message) indicating that the network entity 105-c will enter the NES mode. The UE 115-b may receive the second message while the UE 115-b is in the idle or inactive mode. The second message may indicate for the UE 115-b to perform a cell reselection based on the upcoming entrance of the network entity 105-c into the NES mode. In some examples, the second message may include an indication that the second message is intended for the UE 115-b. For example, the second message may be transmitted according to a configuration that indicates that the second message is intended for the UE 115-b. The second message may be a different message than the first message (e.g., a different message of a different type, or a different message of the same type), or the second message may be a same message as the first message.

In some examples, the second message may include an indication of a change in an SSB configuration, an indication that one or more additional network entities 105 (e.g., one or more additional cells) may enter the NES mode, an indication of a time at which the network entity 105-c may enter into the NES mode, an indication of a duration until the network entity 105-c may enter the NES mode, and/or an indication of a time at which the network entity 105-c may exit the NES mode. For example, the second message may include an indication of a time pattern of one or more durations that the network entity 105-c may be in the NES mode and one or more durations that the network entity 105-c may not be in the first mode of operation (e.g., and may therefore be available for communication). In some examples, the second message may be a SIB (e.g., a SIB1, a SIB2, a SIB3, or another SIB), a paging message, or a DCI message (e.g., with DCI format 2_9). The second message may be a same type of message as the first message (e.g., a SIB), or the second message may be a different type of message relative to the first message (e.g., a paging message or a DCI message).

At 320, the UE 115-b may perform the cell reselection based on receiving the second message. For example, the UE 115-b may establish a connection with a network entity 105-d (e.g., based on the network entity 105-d being indicated via the first message). In some examples, the UE 115-b may perform the cell reselection based at least in part on the reselection criteria. For example, the UE 115-b may establish the connection with the network entity 105-d based on a cell of the network entity 105-d satisfying one or more of the reselection criteria (e.g., communication quality thresholds).

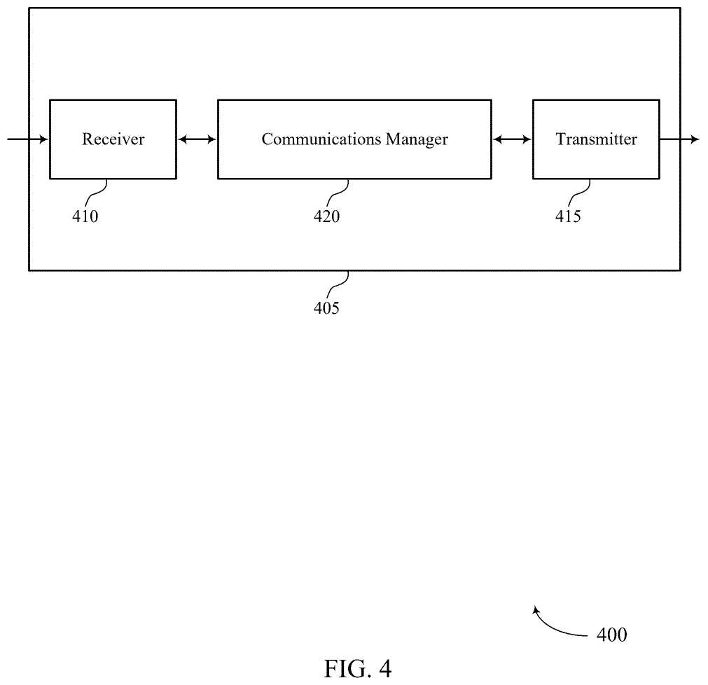

FIG. 4 shows a block diagram 400 of a device 405 that supports indicating cell switch-off to idle or inactive UEs in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to indicating cell switch-off to idle or inactive UEs). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to indicating cell switch-off to idle or inactive UEs). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of indicating cell switch-off to idle or inactive UEs as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving a first message indicating that a network entity is capable of entering a first mode of operation in which the network entity is unavailable for communications. The communications manager 420 is capable of, configured to, or operable to support a means for receiving, while the UE is in an idle mode or an inactive mode, a second message indicating for the UE to perform a cell reselection based on an upcoming entrance of the network entity into the first mode of operation. The communications manager 420 is capable of, configured to, or operable to support a means for performing the cell reselection in response to receiving the second message.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for indicating a cell switch-off to an idle or inactive UE, which may result in more efficient utilization of communication resources related to more efficient cell reselection.

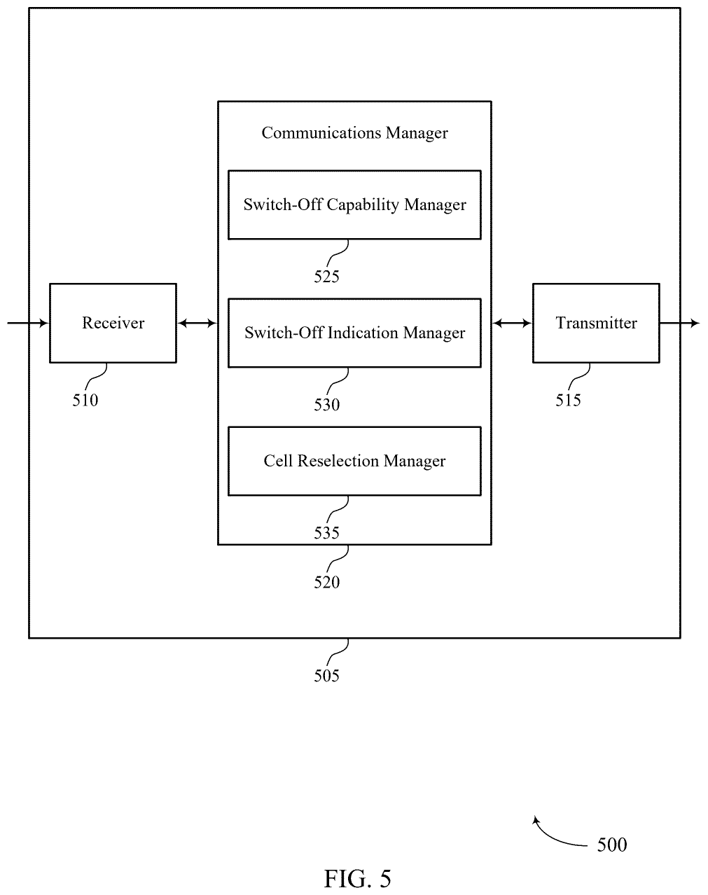

FIG. 5 shows a block diagram 500 of a device 505 that supports indicating cell switch-off to idle or inactive UEs in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to indicating cell switch-off to idle or inactive UEs). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to indicating cell switch-off to idle or inactive UEs). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of indicating cell switch-off to idle or inactive UEs as described herein. For example, the communications manager 520 may include a switch-off capability manager 525, a switch-off indication manager 530, a cell reselection manager 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The switch-off capability manager 525 is capable of, configured to, or operable to support a means for receiving a first message indicating that a network entity is capable of entering a first mode of operation in which the network entity is unavailable for communications. The switch-off indication manager 530 is capable of, configured to, or operable to support a means for receiving, while the UE is in an idle mode or an inactive mode, a second message indicating for the UE to perform a cell reselection based on an upcoming entrance of the network entity into the first mode of operation. The cell reselection manager 535 is capable of, configured to, or operable to support a means for performing the cell reselection in response to receiving the second message.

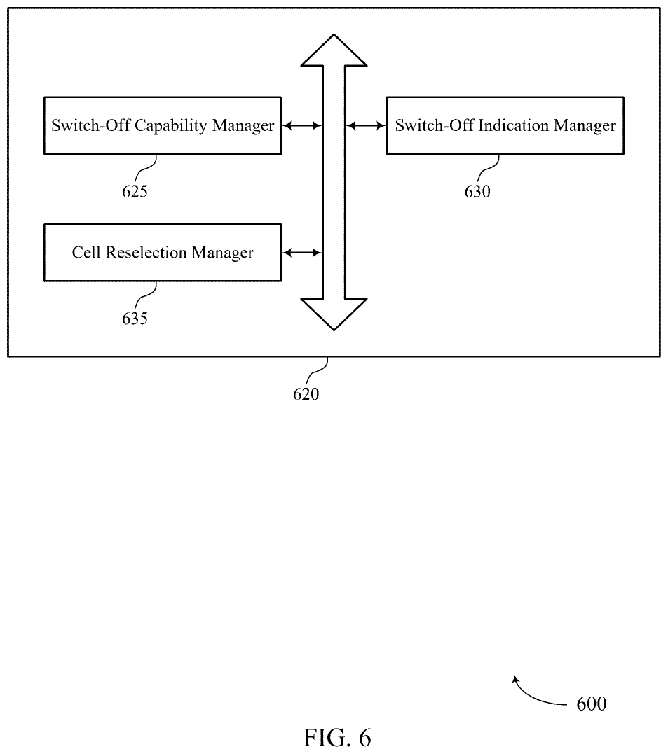

FIG. 6 shows a block diagram 600 of a communications manager 620 that supports indicating cell switch-off to idle or inactive UEs in accordance with one or more aspects of the present disclosure. The communications manager 620 may be an example of aspects of a communications manager 420, a communications manager 520, or both, as described herein. The communications manager 620, or various components thereof, may be an example of means for performing various aspects of indicating cell switch-off to idle or inactive UEs as described herein. For example, the communications manager 620 may include a switch-off capability manager 625, a switch-off indication manager 630, a cell reselection manager 635, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The switch-off capability manager 625 is capable of, configured to, or operable to support a means for receiving a first message indicating that a network entity is capable of entering a first mode of operation in which the network entity is unavailable for communications. The switch-off indication manager 630 is capable of, configured to, or operable to support a means for receiving, while the UE is in an idle mode or an inactive mode, a second message indicating for the UE to perform a cell reselection based on an upcoming entrance of the network entity into the first mode of operation. The cell reselection manager 635 is capable of, configured to, or operable to support a means for performing the cell reselection in response to receiving the second message.

In some examples, the first message is associated with a list of one or more additional network entities, and to support performing the cell reselection, the cell reselection manager 635 is capable of, configured to, or operable to support a means for establishing a connection with a first network entity from among the one or more additional network entities based on the list of the one or more additional network entities.

In some examples, to support receiving the first message, the switch-off capability manager 625 is capable of, configured to, or operable to support a means for receiving, via the first message, an indication of a time at which the network entity will enter into the first mode of operation, a duration until the network entity will enter the first mode of operation, a periodicity associated with the second message, a transmission time for the second message, encoding information associated with the second message, or any combination thereof.

In some examples, to support receiving the second message, the switch-off indication manager 630 is capable of, configured to, or operable to support a means for receiving, via the second message, an indication of a change in a SSB configuration, an indication that one or more additional cells will enter the first mode of operation, an indication of a time at which the network entity will enter into the first mode of operation, an indication of a duration until the network entity will enter the first mode of operation, an indication of a time at which the network entity will exit the first mode of operation, an indication of a time pattern including one or more first durations that the network entity will be in the first mode of operation and one or more second durations that the network entity will not be in the first mode of operation, or any combination thereof.

In some examples, to support receiving the second message, the switch-off indication manager 630 is capable of, configured to, or operable to support a means for receiving, via the second message, an indication that the second message is intended for the UE, where performing the cell reselection is based on the second message being intended for the UE.

In some examples, to support performing the cell reselection, the cell reselection manager 635 is capable of, configured to, or operable to support a means for performing the cell reselection based on one or more reselection criteria, where the one or more reselection criteria are based on a quality associated with one or more additional network entities, and where the one or more reselection criteria are independent of a quality associated with the network entity.

In some examples, the cell reselection manager 635 is capable of, configured to, or operable to support a means for receiving one or more SIBs indicating the one or more reselection criteria, where the one or more reselection criteria include one or more parameters associated with the first mode of operation.

In some examples, the first message includes a SIB message or an RRC message.

In some examples, the second message includes a SIB message, a paging message, or a DCI message.

In some examples, the first message is received while the UE is in the idle mode or the inactive mode.

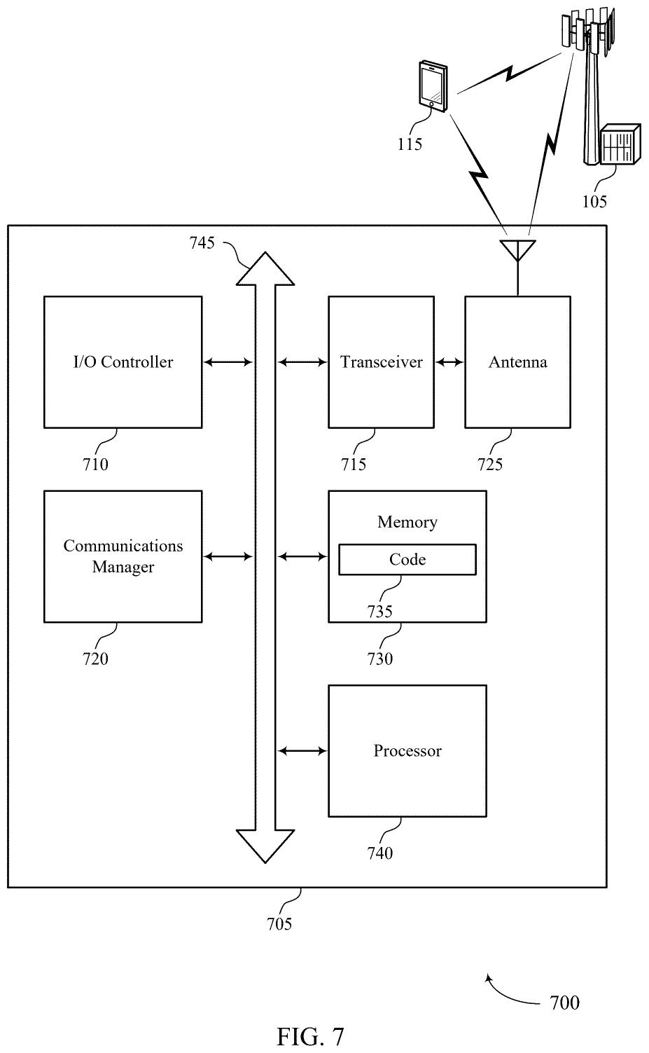

FIG. 7 shows a diagram of a system 700 including a device 705 that supports indicating cell switch-off to idle or inactive UEs in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting indicating cell switch-off to idle or inactive UEs). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving a first message indicating that a network entity is capable of entering a first mode of operation in which the network entity is unavailable for communications. The communications manager 720 is capable of, configured to, or operable to support a means for receiving, while the UE is in an idle mode or an inactive mode, a second message indicating for the UE to perform a cell reselection based on an upcoming entrance of the network entity into the first mode of operation. The communications manager 720 is capable of, configured to, or operable to support a means for performing the cell reselection in response to receiving the second message.

By including or configuring the communications manager 720 in accordance with examples as described herein, the device 705 may support techniques for indicating a cell switch-off to an idle or inactive UE, which may result in improved communication reliability, reduced latency, more efficient utilization of communication resources, and improved coordination between devices.

In some examples, the communications manager 720 may be configured to perform various operations (e.g., receiving, monitoring, transmitting) using or otherwise in cooperation with the transceiver 715, the one or more antennas 725, or any combination thereof. For example, the communications manager 720 may be configured to receive or transmit messages or other signaling as described herein via the transceiver 715. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of indicating cell switch-off to idle or inactive UEs as described herein, or the at least one processor 740 and the at least one memory 730 may be otherwise configured to, individually or collectively, perform or support such operations.

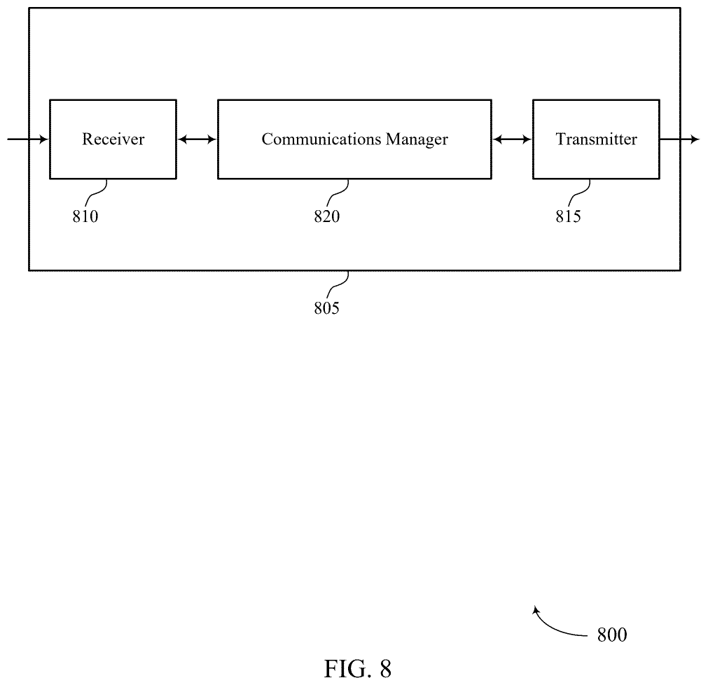

FIG. 8 shows a block diagram 800 of a device 805 that supports indicating cell switch-off to idle or inactive UEs in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of indicating cell switch-off to idle or inactive UEs as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for outputting, to a UE, a first message indicating that the network entity is capable of entering a first mode of operation in which the network entity is unavailable for communications, where the first message indicates for the UE to monitor for a second message while the UE is in an idle or inactive state. The communications manager 820 is capable of, configured to, or operable to support a means for outputting the second message to the UE, where the second message indicates for the UE to perform a cell reselection based on an upcoming entrance of the network entity into the first mode of operation. The communications manager 820 is capable of, configured to, or operable to support a means for entering the first mode of operation after outputting the second message.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for indicating a cell switch-off to an idle or inactive UE, which may result in more efficient utilization of communication resources related to more efficient cell reselection.

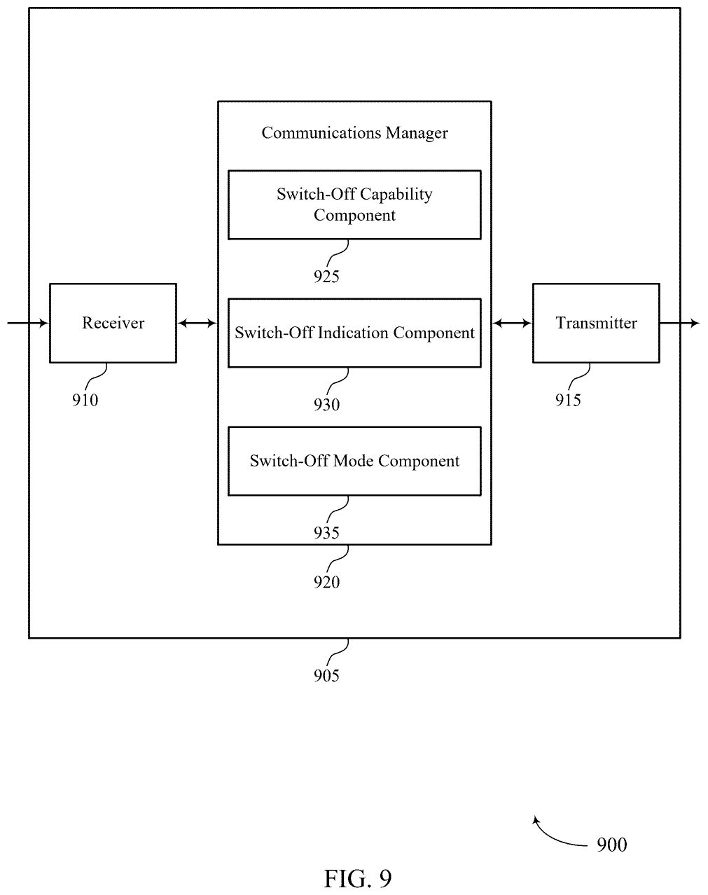

FIG. 9 shows a block diagram 900 of a device 905 that supports indicating cell switch-off to idle or inactive UEs in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of indicating cell switch-off to idle or inactive UEs as described herein. For example, the communications manager 920 may include a switch-off capability component 925, a switch-off indication component 930, a switch-off mode component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The switch-off capability component 925 is capable of, configured to, or operable to support a means for outputting, to a UE, a first message indicating that the network entity is capable of entering a first mode of operation in which the network entity is unavailable for communications, where the first message indicates for the UE to monitor for a second message while the UE is in an idle or inactive state. The switch-off indication component 930 is capable of, configured to, or operable to support a means for outputting the second message to the UE, where the second message indicates for the UE to perform a cell reselection based on an upcoming entrance of the network entity into the first mode of operation. The switch-off mode component 935 is capable of, configured to, or operable to support a means for entering the first mode of operation after outputting the second message.

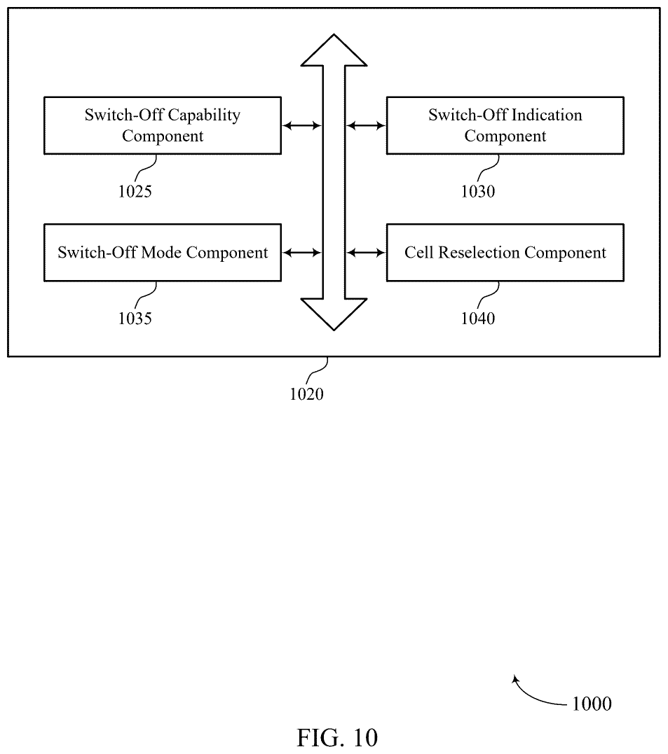

FIG. 10 shows a block diagram 1000 of a communications manager 1020 that supports indicating cell switch-off to idle or inactive UEs in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of indicating cell switch-off to idle or inactive UEs as described herein. For example, the communications manager 1020 may include a switch-off capability component 1025, a switch-off indication component 1030, a switch-off mode component 1035, a cell reselection component 1040, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The switch-off capability component 1025 is capable of, configured to, or operable to support a means for outputting, to a UE, a first message indicating that the network entity is capable of entering a first mode of operation in which the network entity is unavailable for communications, where the first message indicates for the UE to monitor for a second message while the UE is in an idle or inactive state. The switch-off indication component 1030 is capable of, configured to, or operable to support a means for outputting the second message to the UE, where the second message indicates for the UE to perform a cell reselection based on an upcoming entrance of the network entity into the first mode of operation. The switch-off mode component 1035 is capable of, configured to, or operable to support a means for entering the first mode of operation after outputting the second message.

In some examples, the first message is associated with a list of one or more additional network entities, the one or more additional network entities associated with one or more candidate cells for the cell reselection.

In some examples, to support outputting the first message, the switch-off capability component 1025 is capable of, configured to, or operable to support a means for outputting, via the first message, an indication of a time at which the network entity will enter into the first mode of operation, a duration until the network entity will enter the first mode of operation, a periodicity associated with the second message, a transmission time for the second message, encoding information associated with the second message, or any combination thereof.

In some examples, to support outputting the second message, the switch-off indication component 1030 is capable of, configured to, or operable to support a means for outputting, via the second message, an indication of a change in a SSB configuration, an indication that one or more additional cells will enter the first mode of operation, an indication of a time at which the network entity will enter into the first mode of operation, an indication of a duration until the network entity will enter the first mode of operation, an indication of a time at which the network entity will exit the first mode of operation, an indication of a time pattern including one or more first durations that the network entity will be in the first mode of operation and one or more second durations that the network entity will not be in the first mode of operation, or any combination thereof.

In some examples, to support outputting the second message, the switch-off indication component 1030 is capable of, configured to, or operable to support a means for outputting, via the second message, an indication that the second message is intended for the UE.

In some examples, the cell reselection component 1040 is capable of, configured to, or operable to support a means for outputting one or more SIBs indicating one or more reselection criteria, where the one or more reselection criteria include one or more parameters associated with the first mode of operation.

In some examples, the first message includes a SIB message or an RRC message.

In some examples, the second message includes a SIB message, a paging message, or a DCI message.

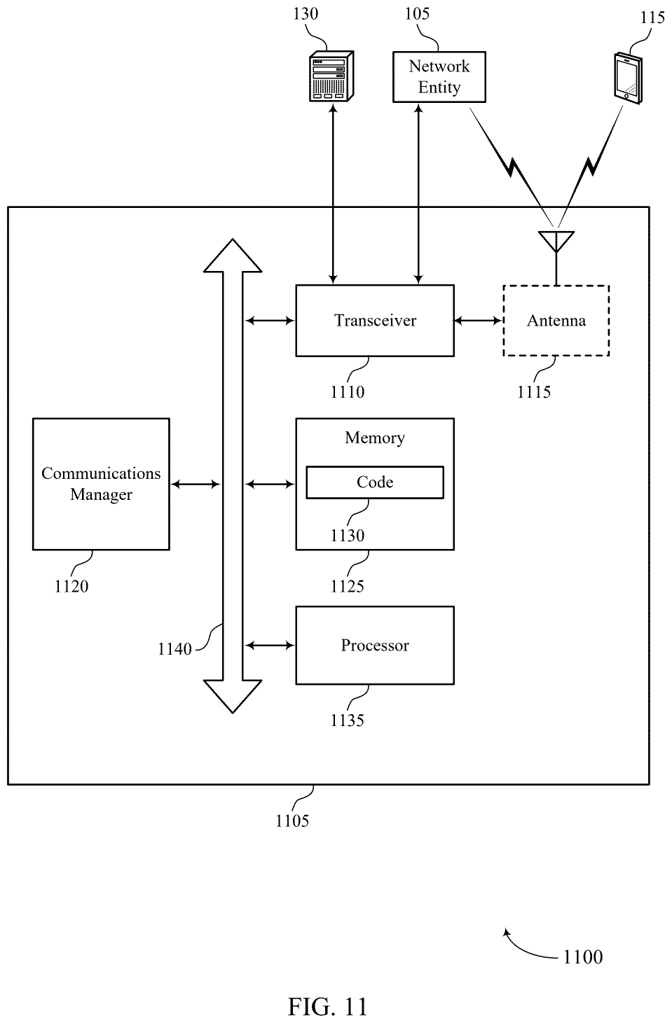

FIG. 11 shows a diagram of a system 1100 including a device 1105 that supports indicating cell switch-off to idle or inactive UEs in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof.

The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting indicating cell switch-off to idle or inactive UEs). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105 and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for outputting, to a UE, a first message indicating that the network entity is capable of entering a first mode of operation in which the network entity is unavailable for communications, where the first message indicates for the UE to monitor for a second message while the UE is in an idle or inactive state. The communications manager 1120 is capable of, configured to, or operable to support a means for outputting the second message to the UE, where the second message indicates for the UE to perform a cell reselection based on an upcoming entrance of the network entity into the first mode of operation. The communications manager 1120 is capable of, configured to, or operable to support a means for entering the first mode of operation after outputting the second message.

By including or configuring the communications manager 1120 in accordance with examples as described herein, the device 1105 may support techniques for indicating a cell switch-off to an idle or inactive UE, which may result in improved communication reliability, reduced latency, more efficient utilization of communication resources, and improved coordination between devices.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. For example, the communications manager 1120 may be configured to receive or transmit messages or other signaling as described herein via the transceiver 1110. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of indicating cell switch-off to idle or inactive UEs as described herein, or the at least one processor 1135 and the at least one memory 1125 may be otherwise configured to, individually or collectively, perform or support such operations.

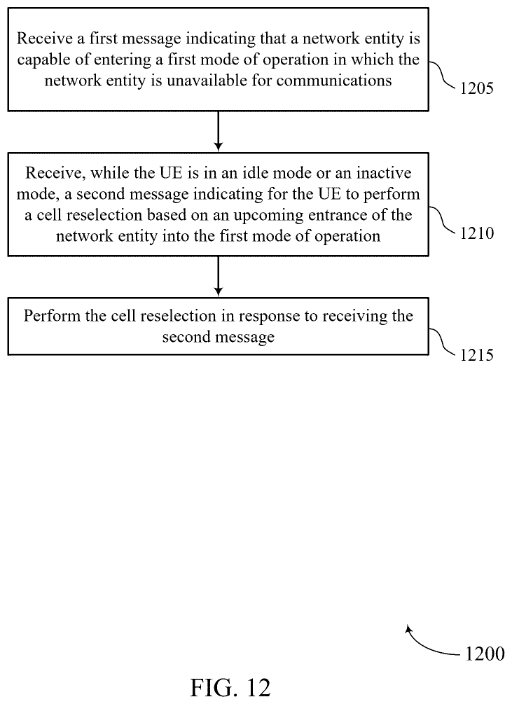

FIG. 12 shows a flowchart illustrating a method 1200 that supports indicating cell switch-off to idle or inactive UEs in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving a first message indicating that a network entity is capable of entering a first mode of operation in which the network entity is unavailable for communications. The operations of 1205 may be performed in accordance with examples as disclosed herein. In some examples, aspects of the operations of 1205 may be performed by a switch-off capability manager 625 as described with reference to FIG. 6. Additionally, or alternatively, means for performing 1205 may, but not necessarily, include, for example, antenna 725, transceiver 715, communications manager 720, memory 730 (including code 735), processor 740, and/or I/O controller 710.

At 1210, the method may include receiving, while the UE is in an idle mode or an inactive mode, a second message indicating for the UE to perform a cell reselection based on an upcoming entrance of the network entity into the first mode of operation. The operations of 1210 may be performed in accordance with examples as disclosed herein. In some examples, aspects of the operations of 1210 may be performed by a switch-off indication manager 630 as described with reference to FIG. 6. Additionally, or alternatively, means for performing 1210 may, but not necessarily, include, for example, antenna 725, transceiver 715, communications manager 720, memory 730 (including code 735), processor 740, and/or I/O controller 710.

At 1215, the method may include performing the cell reselection in response to receiving the second message. The operations of 1215 may be performed in accordance with examples as disclosed herein. In some examples, aspects of the operations of 1215 may be performed by a cell reselection manager 635 as described with reference to FIG. 6. Additionally, or alternatively, means for performing 1215 may, but not necessarily, include, for example, antenna 725, transceiver 715, communications manager 720, memory 730 (including code 735), processor 740, and/or I/O controller 710.

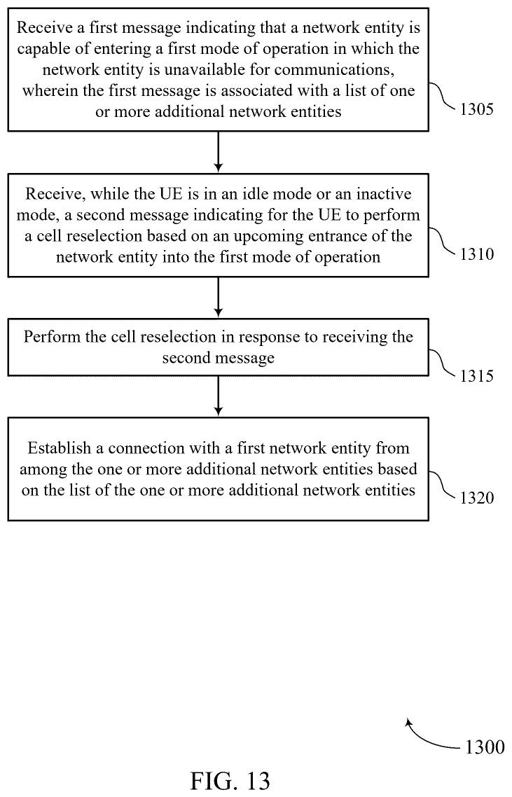

FIG. 13 shows a flowchart illustrating a method 1300 that supports indicating cell switch-off to idle or inactive UEs in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving a first message indicating that a network entity is capable of entering a first mode of operation in which the network entity is unavailable for communications. The operations of 1305 may be performed in accordance with examples as disclosed herein. In some examples, aspects of the operations of 1305 may be performed by a switch-off capability manager 625 as described with reference to FIG. 6. In some examples, the first message may be associated with a list of one or more additional network entities. Additionally, or alternatively, means for performing 1305 may, but not necessarily, include, for example, antenna 725, transceiver 715, communications manager 720, memory 730 (including code 735), processor 740, and/or I/O controller 710.

At 1310, the method may include receiving, while the UE is in an idle mode or an inactive mode, a second message indicating for the UE to perform a cell reselection based on an upcoming entrance of the network entity into the first mode of operation. The operations of 1310 may be performed in accordance with examples as disclosed herein. In some examples, aspects of the operations of 1310 may be performed by a switch-off indication manager 630 as described with reference to FIG. 6. Additionally, or alternatively, means for performing 1310 may, but not necessarily, include, for example, antenna 725, transceiver 715, communications manager 720, memory 730 (including code 735), processor 740, and/or I/O controller 710.

At 1315, the method may include performing the cell reselection in response to receiving the second message. The operations of 1315 may be performed in accordance with examples as disclosed herein. In some examples, aspects of the operations of 1315 may be performed by a cell reselection manager 635 as described with reference to FIG. 6. Additionally, or alternatively, means for performing 1315 may, but not necessarily, include, for example, antenna 725, transceiver 715, communications manager 720, memory 730 (including code 735), processor 740, and/or I/O controller 710.

At 1320, the method may include establishing a connection with a first network entity from among the one or more additional network entities based on the list of the one or more additional network entities. The operations of 1320 may be performed in accordance with examples as disclosed herein. In some examples, aspects of the operations of 1320 may be performed by a cell reselection manager 635 as described with reference to FIG. 6. Additionally, or alternatively, means for performing 1320 may, but not necessarily, include, for example, antenna 725, transceiver 715, communications manager 720, memory 730 (including code 735), processor 740, and/or I/O controller 710.

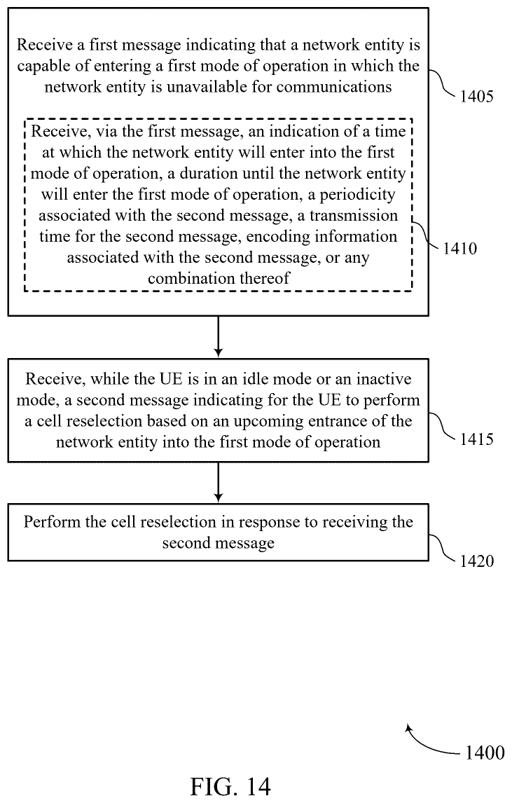

FIG. 14 shows a flowchart illustrating a method 1400 that supports indicating cell switch-off to idle or inactive UEs in accordance with one or more aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1405, the method may include receiving a first message indicating that a network entity is capable of entering a first mode of operation in which the network entity is unavailable for communications. The operations of 1405 may be performed in accordance with examples as disclosed herein. In some examples, aspects of the operations of 1405 may be performed by a switch-off capability manager 625 as described with reference to FIG. 6. Additionally, or alternatively, means for performing 1405 may, but not necessarily, include, for example, antenna 725, transceiver 715, communications manager 720, memory 730 (including code 735), processor 740, and/or I/O controller 710.

In some examples, the method may include, at 1410, receiving, via the first message, an indication of a time at which the network entity will enter into the first mode of operation, a duration until the network entity will enter the first mode of operation, a periodicity associated with the second message, a transmission time for the second message, encoding information associated with the second message, or any combination thereof. The operations of 1410 may be performed in accordance with examples as disclosed herein. In some examples, aspects of the operations of 1410 may be performed by a switch-off capability manager 625 as described with reference to FIG. 6. Additionally, or alternatively, means for performing 1410 may, but not necessarily, include, for example, antenna 725, transceiver 715, communications manager 720, memory 730 (including code 735), processor 740, and/or I/O controller 710.

At 1415, the method may include receiving, while the UE is in an idle mode or an inactive mode, a second message indicating for the UE to perform a cell reselection based on an upcoming entrance of the network entity into the first mode of operation. The operations of 1415 may be performed in accordance with examples as disclosed herein. In some examples, aspects of the operations of 1415 may be performed by a switch-off indication manager 630 as described with reference to FIG. 6. Additionally, or alternatively, means for performing 1415 may, but not necessarily, include, for example, antenna 725, transceiver 715, communications manager 720, memory 730 (including code 735), processor 740, and/or I/O controller 710.

At 1420, the method may include performing the cell reselection in response to receiving the second message. The operations of 1420 may be performed in accordance with examples as disclosed herein. In some examples, aspects of the operations of 1420 may be performed by a cell reselection manager 635 as described with reference to FIG. 6. Additionally, or alternatively, means for performing 1420 may, but not necessarily, include, for example, antenna 725, transceiver 715, communications manager 720, memory 730 (including code 735), processor 740, and/or I/O controller 710.

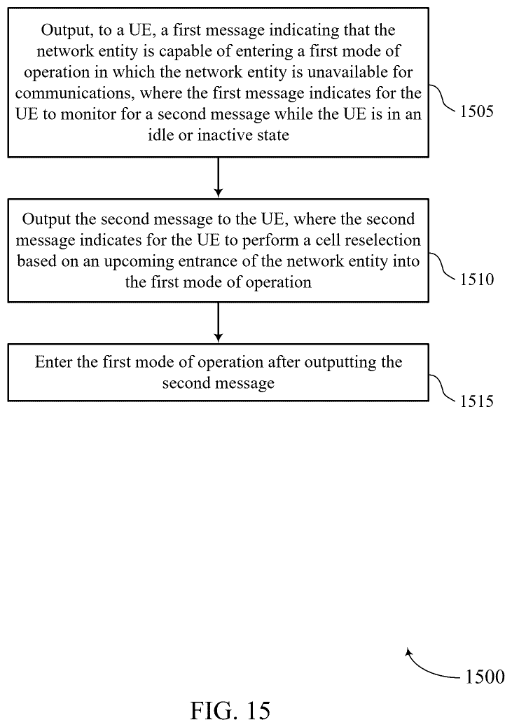

FIG. 15 shows a flowchart illustrating a method 1500 that supports indicating cell switch-off to idle or inactive UEs in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include outputting, to a UE, a first message indicating that the network entity is capable of entering a first mode of operation in which the network entity is unavailable for communications, where the first message indicates for the UE to monitor for a second message while the UE is in an idle or inactive state. The operations of 1505 may be performed in accordance with examples as disclosed herein. In some examples, aspects of the operations of 1505 may be performed by a switch-off capability component 1025 as described with reference to FIG. 10. Additionally, or alternatively, means for performing 1505 may, but not necessarily, include, for example, antenna 1115, transceiver 1110, communications manager 1120, memory 1125 (including code 1130), and/or processor 1135.

At 1510, the method may include outputting the second message to the UE, where the second message indicates for the UE to perform a cell reselection based on an upcoming entrance of the network entity into the first mode of operation. The operations of 1510 may be performed in accordance with examples as disclosed herein. In some examples, aspects of the operations of 1510 may be performed by a switch-off indication component 1030 as described with reference to FIG. 10. Additionally, or alternatively, means for performing 1510 may, but not necessarily, include, for example, antenna 1115, transceiver 1110, communications manager 1120, memory 1125 (including code 1130), and/or processor 1135.

At 1515, the method may include entering the first mode of operation after outputting the second message. The operations of 1515 may be performed in accordance with examples as disclosed herein. In some examples, aspects of the operations of 1515 may be performed by a switch-off mode component 1035 as described with reference to FIG. 10. Additionally, or alternatively, means for performing 1515 may, but not necessarily, include, for example, antenna 1115, transceiver 1110, communications manager 1120, memory 1125 (including code 1130), and/or processor 1135.

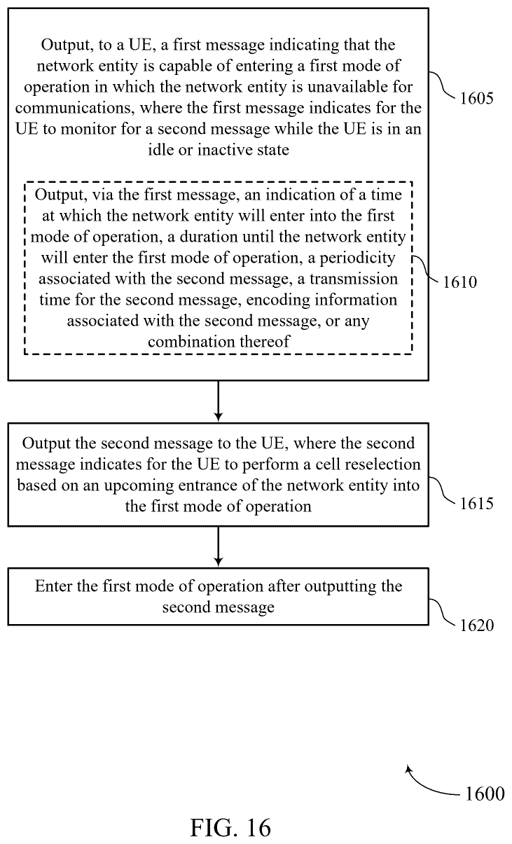

FIG. 16 shows a flowchart illustrating a method 1600 that supports indicating cell switch-off to idle or inactive UEs in accordance with one or more aspects of the present disclosure. The operations of the method 1600 may be implemented by a network entity or its components as described herein. For example, the operations of the method 1600 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1605, the method may include outputting, to a UE, a first message indicating that the network entity is capable of entering a first mode of operation in which the network entity is unavailable for communications, where the first message indicates for the UE to monitor for a second message while the UE is in an idle or inactive state. The operations of 1605 may be performed in accordance with examples as disclosed herein. In some examples, aspects of the operations of 1605 may be performed by a switch-off capability component 1025 as described with reference to FIG. 10. Additionally, or alternatively, means for performing 1605 may, but not necessarily, include, for example, antenna 1115, transceiver 1110, communications manager 1120, memory 1125 (including code 1130), and/or processor 1135.

In some examples, the method may include, at 1610, outputting, via the first message, an indication of a time at which the network entity will enter into the first mode of operation, a duration until the network entity will enter the first mode of operation, a periodicity associated with the second message, a transmission time for the second message, encoding information associated with the second message, or any combination thereof. The operations of 1610 may be performed in accordance with examples as disclosed herein. In some examples, aspects of the operations of 1610 may be performed by a switch-off capability component 1025 as described with reference to FIG. 10. Additionally, or alternatively, means for performing 1610 may, but not necessarily, include, for example, antenna 1115, transceiver 1110, communications manager 1120, memory 1125 (including code 1130), and/or processor 1135.

At 1615, the method may include outputting the second message to the UE, where the second message indicates for the UE to perform a cell reselection based on an upcoming entrance of the network entity into the first mode of operation. The operations of 1615 may be performed in accordance with examples as disclosed herein. In some examples, aspects of the operations of 1615 may be performed by a switch-off indication component 1030 as described with reference to FIG. 10. Additionally, or alternatively, means for performing 1615 may, but not necessarily, include, for example, antenna 1115, transceiver 1110, communications manager 1120, memory 1125 (including code 1130), and/or processor 1135.

At 1620, the method may include entering the first mode of operation after outputting the second message. The operations of 1620 may be performed in accordance with examples as disclosed herein. In some examples, aspects of the operations of 1620 may be performed by a switch-off mode component 1035 as described with reference to FIG. 10. Additionally, or alternatively, means for performing 1620 may, but not necessarily, include, for example, antenna 1115, transceiver 1110, communications manager 1120, memory 1125 (including code 1130), and/or processor 1135.

The following provides an overview of aspects of the present disclosure:

Aspect 1: A method for wireless communications by a UE, comprising: receiving a first message indicating that a network entity is capable of entering a first mode of operation in which the network entity is unavailable for communications; receiving, while the UE is in an idle mode or an inactive mode, a second message indicating for the UE to perform a cell reselection based at least in part on an upcoming entrance of the network entity into the first mode of operation; and performing the cell reselection in response to receiving the second message.

Aspect 2: The method of aspect 1, wherein the first message is associated with a list of one or more additional network entities, and wherein performing the cell reselection comprises: establishing a connection with a first network entity from among the one or more additional network entities based at least in part on the list of the one or more additional network entities.

Aspect 3: The method of any of aspects 1 through 2, wherein receiving the first message comprises: receiving, via the first message, an indication of a time at which the network entity will enter into the first mode of operation, a duration until the network entity will enter the first mode of operation, a periodicity associated with the second message, a transmission time for the second message, encoding information associated with the second message, or any combination thereof.

Aspect 4: The method of any of aspects 1 through 3, wherein receiving the second message comprises: receiving an indication of a change in a SSB configuration, an indication that one or more additional cells will enter the first mode of operation, an indication of a time at which the network entity will enter into the first mode of operation, an indication of a duration until the network entity will enter the first mode of operation, an indication of a time at which the network entity will exit the first mode of operation, an indication of a time pattern comprising one or more first durations that the network entity will be in the first mode of operation and one or more second durations that the network entity will not be in the first mode of operation, or any combination thereof.

Aspect 5: The method of any of aspects 1 through 4, wherein receiving the second message comprises: receiving an indication that the second message is intended for the UE, wherein performing the cell reselection is based at least in part on the second message being intended for the UE.

Aspect 6: The method of any of aspects 1 through 5, wherein performing the cell reselection comprises: performing the cell reselection based at least in part on one or more reselection criteria, wherein the one or more reselection criteria are based at least in part on a quality associated with one or more additional network entities, and wherein the one or more reselection criteria are independent of a quality associated with the network entity.

Aspect 7: The method of aspect 6, further comprising: receiving one or more SIBs indicating the one or more reselection criteria, wherein the one or more reselection criteria comprise one or more parameters associated with the first mode of operation.

Aspect 8: The method of any of aspects 1 through 7, wherein the first message comprises a SIB message or an RRC message.

Aspect 9: The method of any of aspects 1 through 8, wherein the second message comprises a SIB message, a paging message, or a DCI message.

Aspect 10: The method of any of aspects 1 through 9, wherein the first message is received while the UE is in the idle mode or the inactive mode.

Aspect 11: A method for wireless communications by a network entity, comprising: outputting, to a UE, a first message indicating that the network entity is capable of entering a first mode of operation in which the network entity is unavailable for communications, wherein the first message indicates for the UE to monitor for a second message while the UE is in an idle or inactive state; outputting the second message to the UE, wherein the second message indicates for the UE to perform a cell reselection based at least in part on an upcoming entrance of the network entity into the first mode of operation; and entering the first mode of operation based at least in part on outputting the second message.

Aspect 12: The method of aspect 11, wherein the first message is associated with a list of one or more additional network entities, the one or more additional network entities associated with one or more candidate cells for the cell reselection.

Aspect 13: The method of any of aspects 11 through 12, wherein outputting the first message comprises: outputting, via the first message, an indication of a time at which the network entity will enter into the first mode of operation, a duration until the network entity will enter the first mode of operation, a periodicity associated with the second message, a transmission time for the second message, encoding information associated with the second message, or any combination thereof.

Aspect 14: The method of any of aspects 11 through 13, wherein outputting the second message comprises: outputting an indication of a change in a SSB configuration, an indication that one or more additional cells will enter the first mode of operation, an indication of a time at which the network entity will enter into the first mode of operation, an indication of a duration until the network entity will enter the first mode of operation, an indication of a time at which the network entity will exit the first mode of operation, an indication of a time pattern comprising one or more first durations that the network entity will be in the first mode of operation and one or more second durations that the network entity will not be in the first mode of operation, or any combination thereof.

Aspect 15: The method of any of aspects 11 through 14, wherein outputting the second message comprises: outputting an indication that the second message is intended for the UE.

Aspect 16: The method of any of aspects 11 through 15, further comprising: outputting one or more SIBs indicating one or more reselection criteria, wherein the one or more reselection criteria comprise one or more parameters associated with the first mode of operation.

Aspect 17: The method of any of aspects 11 through 16, wherein the first message comprises a SIB message or an RRC message.

Aspect 18: The method of any of aspects 11 through 17, wherein the second message comprises a SIB message, a paging message, or a DCI message.

Aspect 19: A UE for wireless communications, comprising one or more memories storing processor-executable code, a transceiver, and one or more processors coupled with the one or more memories and the transceiver, the one or more processors individually or collectively operable to execute the code to cause the UE to perform a method of any of aspects 1 through 10.

Aspect 20: A UE for wireless communications, comprising at least one means for performing a method of any of aspects 1 through 10.

Aspect 21: A non-transitory computer-readable medium storing code for wireless communications, the code comprising instructions executable by one or more processors to perform a method of any of aspects 1 through 10.

Aspect 22: A network entity for wireless communications, comprising one or more memories storing processor-executable code, and one or more processors coupled with the one or more memories and individually or collectively operable to execute the code to cause the network entity to perform a method of any of aspects 11 through 18.

Aspect 23: A network entity for wireless communications, comprising at least one means for performing a method of any of aspects 11 through 18.

Aspect 24: A non-transitory computer-readable medium storing code for wireless communications, the code comprising instructions executable by one or more processors to perform a method of any of aspects 11 through 18.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code;
a transceiver; and
one or more processors coupled with the one or more memories and the transceiver, the one or more processors individually or collectively operable to execute the code to cause the UE to:
receive, via the transceiver, a first message indicating that a network entity is capable of entering a first mode of operation in which the network entity is unavailable for communications;
receive, via the transceiver and while the UE is in an idle mode or an inactive mode, a second message indicating for the UE to perform a cell reselection based at least in part on an upcoming entrance of the network entity into the first mode of operation; and
perform the cell reselection in response to receiving the second message.

2. The UE of claim 1, wherein the first message is associated with a list of one or more additional network entities, and wherein, to perform the cell reselection, the one or more processors are individually or collectively operable to execute the code to cause the UE to:
establish a connection with a first network entity from among the one or more additional network entities based at least in part on the list of the one or more additional network entities.

3. The UE of claim 1, wherein, to receive the first message, the one or more processors are individually or collectively operable to execute the code to cause the UE to:
receive, via the transceiver and via the first message, an indication of a time at which the network entity will enter into the first mode of operation, a duration until the network entity will enter the first mode of operation, a periodicity associated with the second message, a transmission time for the second message, encoding information associated with the second message, or any combination thereof.

4. The UE of claim 1, wherein, to receive the second message, the one or more processors are individually or collectively operable to execute the code to cause the UE to:
receive, via the transceiver and via the second message, an indication of a change in a synchronization signal block configuration, an indication that one or more additional cells will enter the first mode of operation, an indication of a time at which the network entity will enter into the first mode of operation, an indication of a duration until the network entity will enter the first mode of operation, an indication of a time at which the network entity will exit the first mode of operation, an indication of a time pattern comprising one or more first durations that the network entity will be in the first mode of operation and one or more second durations that the network entity will not be in the first mode of operation, or any combination thereof.

5. The UE of claim 1, wherein, to receive the second message, the one or more processors are individually or collectively operable to execute the code to cause the UE to:
receive, via the transceiver and via the second message, an indication that the second message is intended for the UE, wherein performing the cell reselection is based at least in part on the second message being intended for the UE.

6. The UE of claim 1, wherein, to perform the cell reselection, the one or more processors are individually or collectively operable to execute the code to cause the UE to:
perform the cell reselection based at least in part on one or more reselection criteria, wherein the one or more reselection criteria are based at least in part on a quality associated with one or more additional network entities, and wherein the one or more reselection criteria are independent of a quality associated with the network entity.

7. The UE of claim 6, wherein the one or more processors are individually or collectively further operable to execute the code to cause the UE to:
receive, via the transceiver, one or more system information blocks indicating the one or more reselection criteria, wherein the one or more reselection criteria comprise one or more parameters associated with the first mode of operation.

8. The UE of claim 1, wherein the first message comprises a system information block message or a radio resource control message.

9. The UE of claim 1, wherein the second message comprises a system information block message, a paging message, or a downlink control information message.

10. The UE of claim 1, wherein the first message is received while the UE is in the idle mode or the inactive mode.

11. A network entity, comprising:
one or more memories storing processor-executable code; and
one or more processors coupled with the one or more memories, the one or more processors individually or collectively operable to execute the code to cause the network entity to:
output, to a user equipment (UE), a first message indicating that the network entity is capable of entering a first mode of operation in which the network entity is unavailable for communications, wherein the first message indicates for the UE to monitor for a second message while the UE is in an idle or inactive state;
output the second message to the UE, wherein the second message indicates for the UE to perform a cell reselection based at least in part on an upcoming entrance of the network entity into the first mode of operation; and
enter the first mode of operation after outputting the second message.

12. The network entity of claim 11, wherein the first message is associated with a list of one or more additional network entities, the one or more additional network entities associated with one or more candidate cells for the cell reselection.

13. The network entity of claim 11, wherein, to output the first message, the one or more processors are individually or collectively operable to execute the code to cause the network entity to:
output, via the first message, an indication of a time at which the network entity will enter into the first mode of operation, a duration until the network entity will enter the first mode of operation, a periodicity associated with the second message, a transmission time for the second message, encoding information associated with the second message, or any combination thereof.

14. The network entity of claim 11, wherein, to output the second message, the one or more processors are individually or collectively operable to execute the code to cause the network entity to:
output, via the second message, an indication of a change in a synchronization signal block configuration, an indication that one or more additional cells will enter the first mode of operation, an indication of a time at which the network entity will enter into the first mode of operation, an indication of a duration until the network entity will enter the first mode of operation, an indication of a time at which the network entity will exit the first mode of operation, an indication of a time pattern comprising one or more first durations that the network entity will be in the first mode of operation and one or more second durations that the network entity will not be in the first mode of operation, or any combination thereof.

15. The network entity of claim 11, wherein, to output the second message, the one or more processors are individually or collectively operable to execute the code to cause the network entity to:
output, via the second message, an indication that the second message is intended for the UE.

16. The network entity of claim 11, wherein the one or more processors are individually or collectively further operable to execute the code to cause the network entity to:
output one or more system information blocks indicating one or more reselection criteria, wherein the one or more reselection criteria comprise one or more parameters associated with the first mode of operation.

17. The network entity of claim 11, wherein the first message comprises a system information block message or a radio resource control message.

18. The network entity of claim 11, wherein the second message comprises a system information block message, a paging message, or a downlink control information message.

19. A method for wireless communications by a user equipment (UE), comprising:
receiving a first message indicating that a network entity is capable of entering a first mode of operation in which the network entity is unavailable for communications;
receiving, while the UE is in an idle mode or an inactive mode, a second message indicating for the UE to perform a cell reselection based at least in part on an upcoming entrance of the network entity into the first mode of operation; and
performing the cell reselection in response to receiving the second message.

20. The method of claim 19, wherein the first message is associated with a list of one or more additional network entities, and wherein performing the cell reselection comprises:
establishing a connection with a first network entity from among the one or more additional network entities based at least in part on the list of the one or more additional network entities.
